(19) United States
(12) Patent Application Publication
(10) Pub. No.: US 2007/0130725 A1
(43) Pub. Date: Jun. 14, 2007

(54) Precision machined roller wheel assembly

(76) Inventor: John Ness, Stillwater, MN (US)

Correspondence Address: Janet P. Schafer;SCHAFER LAW OFFICE, P.A., 727 Torchwood Circle, New Brighton, MN, 55112-2538, US

(21) Appl. No.: 11/700,344

(22) Filed: Jan. 31, 2007

Related U.S. Application Data
(62) Division of application No. 10/871,784, filed on Jun. 18, 2004.
(60) Provisional application No. 60/479,542, filed on Jun. 18, 2003.
(60) Provisional application No. 60/525,561, filed on Nov. 26, 2003.

(51) Int. Cl. E05D 15/16

(52) U.S. Cl. 16/105

(57) ABSTRACT

Apparatus and method for wheel assemblies, specifically directed to precision roller wheel assembly for use with patio doors or the like, that provides a rust-resistant, salt resistant wheel assembly for providing a smooth gliding, quiet operating, easy to adjust, door wheel system that is corrosion free and is believed to be able to withstand hurricane force winds. A precision roller wheel assembly for use on a lower surface of a door, especially a patio door or the like, the assembly comprising a two-piece housing, the two-pieces being a mirror image of each other, for receiving at least one precision machined corrosion resistant sealed roller wheel mounted on an axle, means for mounting the assembly to a patio door or the like, and adjustment means for vertically adjusting the assembly in its position of use.

This application is a DIVISIONAL APPLICATION OF non-provisional application, Ser. No. 10/871,784 filed Jun. 18, 2004 under 35 U.S.C. §111(a), hereby incorporated by reference.

### BACKGROUND

This invention is generally directed to wheel assemblies, and is specifically directed to a precision machined roller wheel assembly for use with patio doors or the like. It will be appreciated that the precision machined wheel roller assembly could have many uses but it has been specifically designed for rolling or sliding patio doors.

### SUMMARY

The present invention is directed to a precision machined roller wheel assembly that provides a rust-resistant, salt resistant wheel assembly for providing a smooth gliding, quiet operating, easy to adjust, door wheel system that is corrosion free and is believed to be able to withstand hurricane force winds. A precision roller wheel assembly for use on a lower surface of a door, especially a patio door or the like, the assembly comprising a two-piece outer housing, the two-pieces being a mirror image of each other, an inner housing for receiving at least one precision machined corrosion resistant roller wheel mounted on an axle, means for mounting the assembly to a patio door or the like, and adjustment means for vertically adjusting the assembly in its position of use. The at least one precision machined roller wheel is a corrosion resistant wheel made of one of a group of materials including stainless steel, aluminum, copper, metal alloys such as aluminum bronze, plastic acetyl composites such as Dupont Delrin®, nylon, neoprene, or combination of these or similar materials. The wheels are sealed to bearings. An inner lip of axle receiving wheel aperture holds bearing in place and provides a surface against which bearing may be pressure fit by spring washer or the like. Additionally, snap ring, adhesive or the like may be applied to the wheel inner aperture to aid in retention of bearing. This sealing of the wheels to the bearings and thus to the axle, prevents foreign matter from getting into the wheel and thereby causing deterioration of the wheel.

The precision roller wheel assembly wherein the adjustment means for adjusting the assembly in its position of use further comprise an end adjustment screw received by apertures in both the outer housing and the inner housing fastening the inner housing relative to the outer housing such that the at least one wheel, while adjustable vertically, once in the desired position, is fastened into place holding the inner housing stable relative to the outer housing. The precision machined roller wheel assembly fitting into a pocket within a bottom edge of the door or the like for use.

A precision roller wheel assembly for use with a patio door or the like, the assembly comprising a two-piece type housing wherein the sides are the mirror image of each other, a third piece of housing for mounting the assembly to a patio door or the like, a pair of corrosion resistant wheels, a pair of axles for holding the pair of wheels in place between the two-piece housing, means for sealing each wheel to an axle, and an end adjustment screw as adjustment means for adjusting the assembly in its position of use.

The precision roller wheel assembly wherein the adjustment means for side adjusting the assembly in its position of use further comprise a cam gear. The cam gear further comprises an irregularly shaped generally planar oval having multiple projections inter-spaced between concavities of varying sizes forming the edge thereof. The assembly wherein the cam gear further comprises an adjustment arm formed central to and extending horizontally from the irregularly shaped oval, the adjustment arm received in a snap fit manner by a groove formed in the mounting bracket of the housing. The precision roller wheel assembly wherein the adjustment means further comprise manually turning the cam gear such that the mounting bracket there-attached moves vertically to fill space as needed between a patio door, or the like, and the track of the door. The precision roller assembly wherein said adjustment means permits raising or lowering the patio door, or the like, in its position of use such that the patio door easily and quietly moves yet resists environmental forces including corrosion and wind deflection.

A method of manufacturing a roller wheel assembly having the steps of precision machining wheel proportions into metal materials selected from a group including stainless steel, aluminum, copper metal alloys, and plastic acetyl. The wheel having a relatively deep inner groove and relatively thicker sidewalls such that the outer dimensions remains the industry standard size; processing the wheel by de-burring and coating by one of a group including anodizing and metal plating; machining a two-piece outer housing of required dimensions of materials selected from a group including stainless steel, aluminum, copper metal alloys, and plastic acetyls. The machining step further including forming a horizontal machined slot, a vertical groove and a recess formed in the first end joining ends of the outer housing, such that a boss of formed in one piece of the two-piece housing and a matching counter-bore formed in the second piece of the two-piece outer housing; processing the outer housing by de-burring and coating the metal materials; machining a one piece inner housing of required dimensions of materials selected from a group including stainless steel, aluminum, copper, metal alloys, and acetyl composites, the inner housing formed with closed ends; processing the inner housing by de-burring and coating the metal materials and machining a pair of wheel mounting notches formed diagonally in side walls thereof and a boss pin and a recess; assembling the wheel by positioning axle into a bearing; press fitting the bearing into the wheel, locking the bearing into place with a snap ring and washer; positioning the two-piece outer housing about the wheel mounted inner housing and fastening with fastening means; and providing an adjustment screw positioned at an end for vertically adjusting the in position roller wheel assembly. The above process with the further step of inserting a rubber insert into a groove machined into the wheel as a shock absorber.

A method of manufacturing a roller wheel assembly having the steps of precision machining wheel proportions into metal materials selected from a group including stainless steel, aluminum, copper metal alloys, and plastic acetyls, the wheel having a relatively deep inner groove and relatively thicker sidewalls such that the outer dimensions remains the industry standard size; processing the wheel by de-burring and coating by one of a group including anodizing and metal plating; machining a two-piece outer housing of metal materials selected from a group including stainless steel, aluminum, copper metal alloys, and plastic acetyls, into desired dimensions and further machining a pair of vertical grooves in each of the two piece outer housing and machining a pair members one on the inside sidewall of each of the two-piece outer housing; providing on each end of the two-piece outer housing a boss and a counter bore for tightly fitting the two-piece outer housings together; machining a one-piece inner housing into desired proportions from metal materials selected from a group including stainless steel, aluminum, copper metal alloys, and plastic acetyls, further; machining a pair of wheel mounting diagonal notches in each sidewall of the inner housing; providing a pair of wheel assemblies as described above; providing a spacer received by the members of the inner housing and received by a movement slot machined into each sidewall of the inner housing; positioning the two-piece outer housing about the wheel mounted inner housing and fastening with fastening means; and providing an adjustment screw positioned at an end for vertically adjusting the in position roller wheel assembly. The above process with the further step of inserting a rubber insert into a groove machined into the wheel as a shock absorber.

A method of manufacturing a roller wheel assembly having the steps of precision machining wheel proportions into metal materials selected from a group including stainless steel, aluminum, copper metal alloys, and plastic acetyls, the wheel having a relatively deep inner groove and relatively thicker sidewalls such that the outer dimensions remains the industry standard size; processing the wheel by de-burring and coating by one of a group including anodizing and metal plating; machining a two-piece housing of materials selected from a group including stainless steel, aluminum, copper metal alloys, and plastic acetyls, into desired dimensions; further machining an inner surface on the inside side walls of the two-piece housing, providing a cam gear received by the inner surface, the cam gear side positioned to raise or lower a bracket mounting machined from materials selected from a group including stainless steel aluminum, copper metal alloys, and plastic acetyls, the bracket mounting snap fit onto the wheel mounted assembled two-piece housing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which an embodiment of the invention is illustrated.

### BRIEF DESCRIPTION OF THE DRAWINGS

Understanding of the invention will be enhanced by referring to the accompanying drawings, in which like numbers refer to like parts in the several views and in which:

FIG. 1 is a series of views of the single wheel precision machined roller wheel assembly of this invention with FIG. 1A a top plan view, FIG. 1B a front end view, FIG. 1C a side view with the wheel shown in the maximum retracted position, with portions shown in phantom, and FIG. 1D a side view with the wheel shown in the maximum extended position;

FIG. 2 is an exploded view of a single wheel embodiment of FIG. 1;

FIG. 3 is an exploded view of the double wheel precision machined roller wheel assembly of this invention;

FIG. 4 is a series of views of the double wheel precision machined roller wheel assembly of this invention with FIG. 4A a top plan view, FIG. 4B a front end view, FIG. 4C a side view with the wheels shown in the maximum retracted position, with portions shown in phantom, and FIG. 4D a side view with the wheels shown in the maximum extended position;

FIG. 5 is a side view of an alternate embodiment double wheel precision machined roller wheel assembly with cam gear adjustment means;

FIG. 6 is a top view of the device of FIG. 5;

FIG. 7 is an exploded view of the device of FIG. 5;

FIG. 8 is an end view of the device of FIG. 5;

FIG. 9 is a series of views of the alternate embodiment double wheel precision machined roller wheel assembly of FIG. 5 with parts removed to permit understanding of the invention, FIG. 9A illustrates the two-wheeled device of this invention with the cam gear 16 in its lowermost position and each subsequent figure illustrating the cam gear 16 in varying raised positions with FIG. 9E illustrating the cam gear 16 in its uppermost position;

FIG. 10 is an exploded view of an alternate embodiment double wheel precision machined roller wheel assembly with cam gear adjustment means;

FIG. 11 is an end view of the device of FIG. 10; and

FIG. 12 is a series of view of the wheel used in all embodiments with FIG. 12A a side plan view of the wheel, FIG. 12B an end view with the wheel insert shown, FIG. 12C a cross-sectional view as indicated by arrows in FIG. 12A, and FIG. 12D a perspective view of a two-piece wheel.

### DETAILED DESCRIPTION OF THE EMBODIMENTS

Understanding of the invention will be further enhanced by referring to the following illustrative but non-limiting example.

A precision machined roller wheel assembly 110, for mounting to the bottom surface of a door, especially a patio door, or the like, satisfies these needs to provide a rust resistant, salt resistant wheel assembly that provides a smooth gliding, quiet operating, easy to adjust door wheel system, or the like, that is believed able to withstand hurricane force winds. A precision machined roller assembly that may be used in new manufacture and be retro-fit into existing patio doors and the like.

In a precision machined roller wheel assembly 110, at least one wheel 126 is retained within the housing 112 by an axle 114 permitting the precision machined roller wheel assembly 110 to move along a track. The precision machined roller wheel assembly 110, once in position in a patio door or the like, is vertically adjustable. The precision machined roller wheel assembly 110 is adjusted manually such that the patio door, or the like, is either raised, or lowered depending on the need, such that the patio door is easily mounted into place and adjusted to tightly fit the attached patio door into the desired position yet permitting the patio door to smoothly glide, and quietly operate. Once the wheel 126 is in the desired location, vertical adjustment screw 138 is tightened holding the wheel 126 in position.

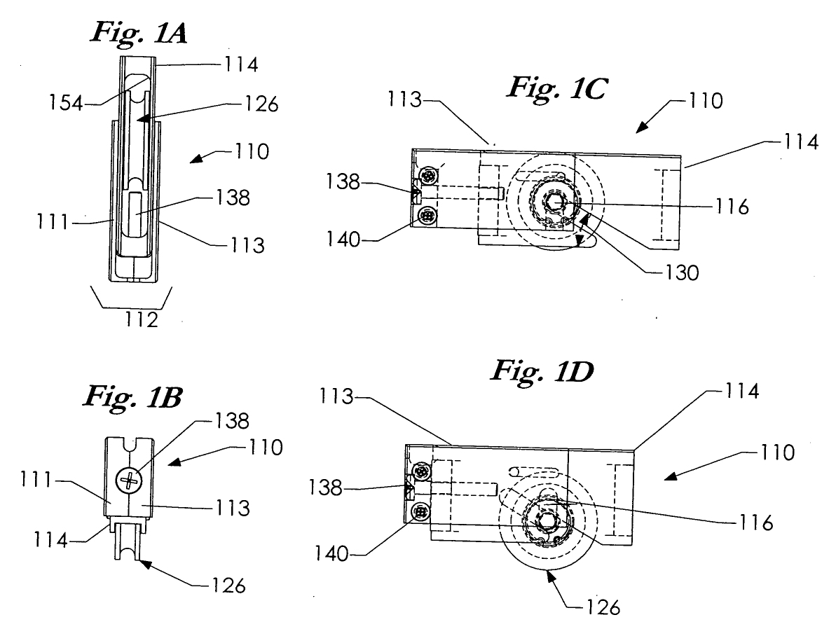

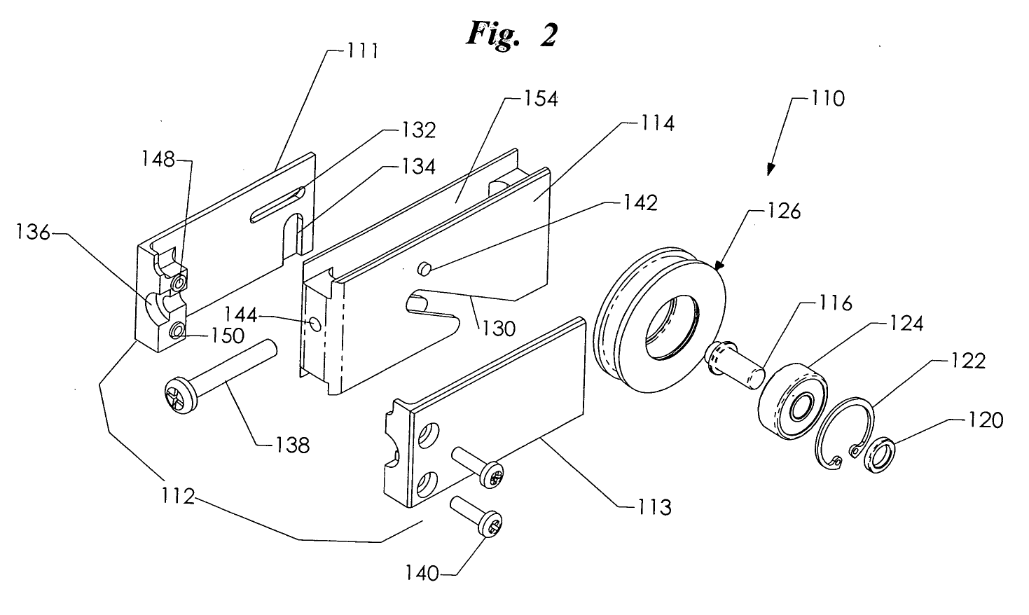

A precision machined roller wheel assembly 110 using a single wheel is shown at FIGS. 1A-1D & 2. The single wheeled precision machined roller wheel assembly 110 has a two-piece outer housing 112, a left housing 111 and a right housing 113, that fit and are held together by fastening means, such as brass screws 140. The two-piece outer housing 112, when assembled, has a U-shaped construction with a closed front and open back. Left housing 111 has a boss 150 extending from each screw-receiving recess 148 while the right housing 113 has a counter bore for receiving the boss 150. This fitting together of the boss 150 and counter bore keeps the assembled two-piece outer housing 112 in close alignment preventing rotation of the housing parts in relation to each other. Machining these parts permits a close fit whereas stamping, the prior manufacturing process for making door wheel assemblies, would not permit this desirable close fit. The use of brass screws 140, or other fastening means, further strengthens the fastening together of the two-piece housing. This close alignment, in addition to the precision machining rather than stamping out of the parts, enables use of more material in the construction of the element parts. Because the alignment is enhanced in this manner, closer tolerance of the housing parts and parts housed is permitted. This enhanced alignment and precision machining allows for a tight fit of the component parts which in turn permits more material to be used in forming the side walls of the housings and the wheel itself, strengthening the assembly as a whole.

A one-piece inner housing 114, connected at both ends, is provided that has a central cavity 154 that receives a wheel 126. The inner housing acts as a wheel guide limiting the vertical movement of wheel 126. The wheel 126 is held in position within inner housing 114, by axle 116 mounted to the wheel 126 which is in turn received by a diagonal notch 130 formed on both sidewalls of inner housing. Diagonal notch 130 is open at a distal end which permits the axle-mounted wheel 126 to move up and down the notch 130 within the housings allowing vertical adjustment of the wheel assembly and attached patio door or the like. Axle 116 extends beyond the outer sidewalls of inner housing 114 and is received by a vertical groove 134 formed in the outer housing 112. Vertical groove 134 does not extend through the sidewalls of the outer housing 112 but rather is a groove for receiving an end of wheel mounted axle 116. The precision machining of the outer housing 112 and the inner housing 114 permits the inner housing 114 to move horizontally within the two-piece outer housing 112. Also present on each an outer surface of each side wall of the inner housing 114 is a boss pin 142 positioned such that it is received by counter-machined slot 132 machined horizontally into each of the left housing 111 and right housing 113. When assembled, the boss pin 142 fits into and is received by counter-machined slot 132, and wheel mounted axle 116 fits into and is received by diagonal notch 130 the extended axle is received by groove 134. The assembled roller wheel assembly 110 is retained in position by a combination of the boss 150 and counter bore and fastening means such as screws 140. Boss pin 142 and counter-machined slot 132 arrangement aids in stabilizing the assembled wheel-mounted inner housing 114 and the outer housing 112. This stabilized assembly 110 stops rotation of the element parts in relation to each other providing resistance to environmental forces such as wind.

A recess 136 is formed, half on each of the two piece outer housing parts 111, 113, for receiving the vertical adjustment screw 138. The vertical adjustment screw 138 is further received by an aperture 144 formed in the inner housing 114. The wheel 126, mounted on the axle 116, is received by a diagonal notch 130 and moves diagonally along this notch 130, permitting inner housing 114 to move horizontally within assembly in response to adjustment by adjustment screw 138. Because the axle 116 which extends from the exterior of the diagonal notch 130 is captured by the vertical groove 134 formed in the outer housing 112, when the two-piece outer housing 112 is assembled, and the boss pin 142 of the inner housing 114 moves horizontally along the counter-machined slot 132 machined in the two-piece outer housing 112, the wheel 126 is held in place within the assembly 110 yet may be adjusted. The unique manner in which the wheel 126 is retained within the assembly 110 permits the wheel 126 to be adjusted vertically such that the vertical displacement of the patio door mounted assembly permits the door to be easily fitted to the space available. The combination of inner housing 114, with the axle 116 receiving diagonal notch 130, and the groove 134 machined into outer housing 112, acts as a stop to limit the minimum and maximum vertical movement of the wheel 126. Once the wheel 126 is in the desired location, vertical adjustment screw 138 is tightened holding the wheel 126 firmly in position.

Wheel 126 is press fit to bearing 124. The axle 114 is press fit to bearing 124. The bearing 124 is sandwiched between the wheel 126 and axle 114. In actual use conditions, a stainless steel bearing 124 is used to increase corrosion resistance, although other bearings with similar characteristics, such as could be used. Bearing 124 is held in position by retaining ring 122 and washer 120.

Wheel 126, in actual use conditions, is of aluminum bronze, stainless steel, aluminum, copper, or plastic acetyl compositions such as Dupont Delrin® a nylon, Neoprene®, a DuPont material, or combination material, although other materials such as special composites, could be used. Wheel 126 is shown with a groove 127 formed therein to enable the wheel 126 to follow a track, such as one surrounding a patio door. It is understood that grooves 127 of other sizes and shapes could be utilized such as a flat-sided inverted U-shape track, or a rounded track In the present invention, while the outside dimension of the wheel 126 is similar to other patio door wheels, the side walls of wheel 126 are relatively thicker than those used previously and wheel 126 has a relatively deeper groove 127 to receive track to aid in resistance to movement of the patio door mounted assembly 110 as a result of environmental forces, such as wind thus providing increased resistance to example hurricane force winds.

Wheel 126 is received by the pair of notches 130 formed in the sidewall of the inner housing 114. One side of outer housing 112 is fitted over inner housing 114 such that the boss pin 150 on inner housing 114, is received by the counter-machined slot 132 and the axle extending from the inner housing 114 is received by groove 134 formed in outer housing 112. The second outer housing part is then mounted about the inner housing 114 such that the boss pin 150 on inner housing 114, is received by the counter-machined slot 132 and the axle extending from the inner housing 114 is received by groove 134. Brass screws 140 are then used as fastening means to hold the assembly 110 together. The assembly 110 is received by a pocket formed in the lower edge of the door.

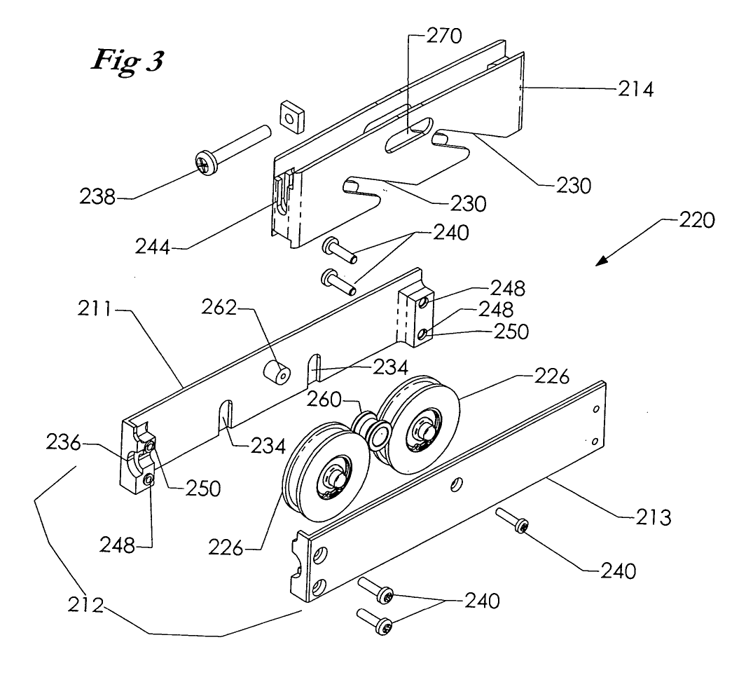

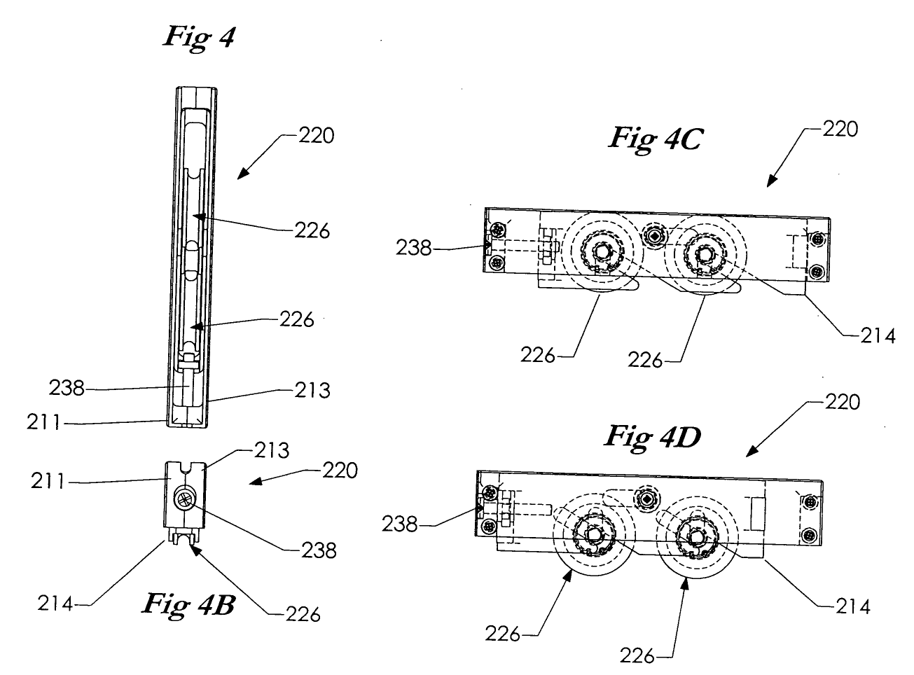

A precision machined roller wheel assembly 220 having a pair of wheels is shown at FIGS. 3 & 4. The double wheeled precision roller wheel assembly 220 has a two-piece outer housing 212, with a left side outer housing 211 and a right side outer housing 213, having a pair of shoulders 246 formed therein, that fit together and are held by a boss 250 and counter-bore 248 system, as described above for the single wheel embodiment, with additional fastening means, such as brass screws 240. The two-piece outer housing 212, when assembled, has an elongated O-shaped construction with closed ends. A pair of shoulders 246 are machined into each end of each of the two-piece outer housings 212. Left side outer housing 211 has a boss 250 extending from each screw-receiving counter-bore 248 mounted on the shoulder 246 at each end while the right side outer housing 223 has a counter bore associated with a screw-receiving counter-bore 248 formed in the shoulder 246 at each end for receiving the boss 250. This fitting together of the boss 250 and counter bore 248 keeps the assembled two-piece housing 212 in close alignment preventing rotation of the housing parts in relation to each other. The forming of shoulders at both ends of each of the two-piece housings 212 include additional material increasing the bracing of the two-piece housing 212. The use of brass screws 240, or other fastening means, received two on each side at opposite ends and on opposite sides of the outer housing 212 further strengthens the fastening together of the two-piece housing. This close alignment, in addition to the precision machining rather than stamping out of the parts, enables use of more material in the construction of the element parts than has been used in the past. Because the alignment is enhanced in this manner, closer tolerance of the housing parts and parts housed is permitted. This enhanced alignment and precision machining allows for a tight fit of the component parts which in turn permits more material to be used in forming the side walls of the housings and the wheel itself, strengthening the assembly as a whole.

In addition to the boss 250 and counter-bore 248 arrangement, the outer housing 212, because it is almost twice as long as the single wheel outer housing 112, has a spacer 260, in actual use of brass and similar to a bushing or nut that is receivably mounted on a tube-like member 262 that, in actual use conditions is formed half on the left side outer housing 211 and half on the right side outer housing 213 although a one-piece projection, extending from either side of the outer housing 212 could be used. The member 262 acts as a spacer also to prevent the outer housing 212 from being deformed under pressure such that it pinches the wheels 226 and blocks movement of the assembly 220. The tube-like member 262 receives a brass screw 240, or the like, to firmly attach the two-piece housing 212 about the inner housing 214 and pair of wheels 226. The projection 262 and the spacer 260 both stabilize the assembly 220.

The inner housing 214, of one-piece construction and connected at both ends with an elongated inside dimension pocket, is, in actual use conditions, of stainless steel although other rigid materials could be used. Machined into each side wall is a pair of diagonal wheel mounting notches 230 formed opposite each other in both sidewalls, two notches per sidewall, each pair of notches for receipt of a wheel-mounted axle. The wheel mounting notches 230 in the sidewalls of the inner housing 214 acts as a wheel guide limiting the movement of each wheel 226. Each diagonal wheel mounting notch 230 is open at a distal end which permits the axle-mounted wheel 226 to move up and down the notch 230 within the housings allowing vertical adjustment of the wheel assembly and attached patio door or the like. Axle 216 extends beyond the outer sidewalls of inner housing 214 and is again received by a pair of vertical grooves 234 formed in each side of the outer housing 212. The precision machining of the outer housing 212 and the inner housing 214 permits the wheel-mounted inner housing 214 to move within the two-piece outer housing 212. When assembled, the wheel-mounted axle 216 fits into and is received by the pair of diagonal notches 230 and the portion of the axle 216 which extends beyond the sidewalls of the inner housing 214 is received by the pair of grooves 234. The assembly 220 is retained in position by a combination of the boss 250 and counter bore and fastening means such as screws 240 received by the recess 248 also formed in the shoulder. Also formed into each side-wall of the inner housing 214 is a sidewall movement slot 270 that receives tube-like member 262. Spacer 260 sits on tube-like member 62 and is of a size and dimension to fit within the inner confines of the inner housing 214. Sidewall movement slot 270 receives member mounted spacer 260 permitting inner housing 214 to move horizontally within outer housing 212 allowing assembly to be adjusted vertically bu end received adjustment screw 238. Formed in one end of the inner housing 214 is a recessed aperture for receipt of vertical adjustment screw 238.

The boss 250 and counter-machined recess arrangement aids in stabilizing the assembled wheel-mounted inner housing 214 and the outer housing 2112. This stabilized assembly 220 stops rotation of the element parts in relation to each other providing resistance to environmental forces such as wind.

Wheel 226 is press fit to bearing 224. The axle 214 is press fit to bearing 224. The bearing 224 is sandwiched between the wheel 226 and axle 214. In actual use conditions, a stainless steel bearing 224 is used to increase corrosion resistance, although other bearings with similar characteristics, such as could be used. Bearing 224 is held in position by retaining ring 222 and washer 220.

Wheel 226, in actual use conditions, is of aluminum bronze, stainless steel, aluminum, copper, or plastic acetyl compositions such as Dupont Delrin® nylon, neoprene or combination material, although other materials such as other plastics or special composites, could be used. Wheel 226 is shown with a groove 227 formed therein to enable the wheel 226 to follow a track, such as one surrounding a patio door. It is understood that grooves 227 of other sizes and shapes could be utilized such as a flat-sided inverted U-shape track, or a rounded track In the present invention, while the outside dimension of the wheel 226 is similar to other patio door wheels, the side walls of wheel 226 are relatively thicker than those used previously and wheel 226 has a relatively deeper groove 227 to aid in resistance to movement of the patio door mounted assembly 220 as a result of environmental forces, such as wind thus providing increased resistance to example hurricane force winds.

Spacer 260 is placed in an inverted inner housing 214 and aligned with horizontal notch 270. The pair of wheels 226 mounted on axles 216 is then received by the diagonal notches 230. One side 211 of the outer housing 212 is the mounted about the inner housing 214 with the tube-like member 262 being received by the spacer 260, a guide placed central of the spacer 260 aids in alignment of the outer housing. The other side 213 of the outer housing 212 with its tube-like member 262 is then received by the spacer 260, and the boss 250 and counter-machined recess fitted together. Once in place, brass screws 240 are used to hold the assembly 220 together. The vertical adjustment screw 238 is then received by the central recess 236 in two-piece housing 112 and by aperture 244 in inner housing 214.

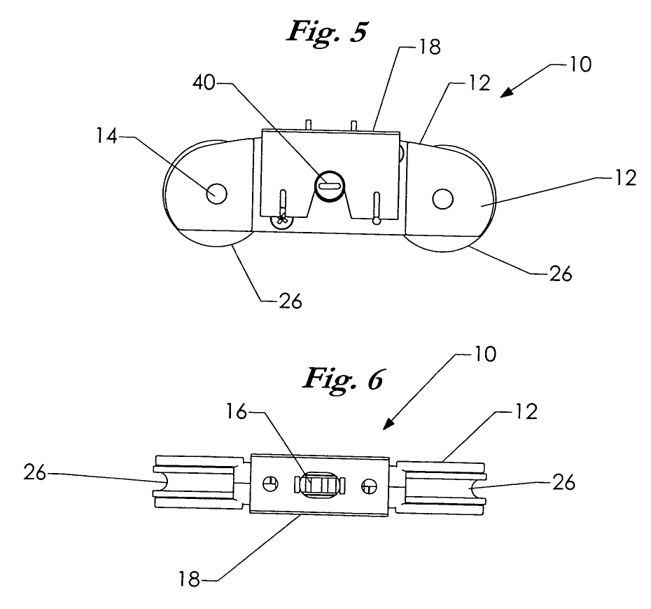

In precision roller wheel assembly 10 shown in FIGS. 5-8, two wheels 26 are retained within a two-piece housing 12 by a pair of axles 14 that permit the precision roller wheel assembly 10 to move along a track. The bracket mounting 18, is carried by the housing 12 and is vertically adjustable by cam gear 16. Bracket mounting 18 is adjusted by manually adjusting can gear 16 by means of slot 40, formed into cam gear 16, and permits adjustment of cam gear 16 such that the bracket mounting 18 is either raised, or lowered depending on the need.

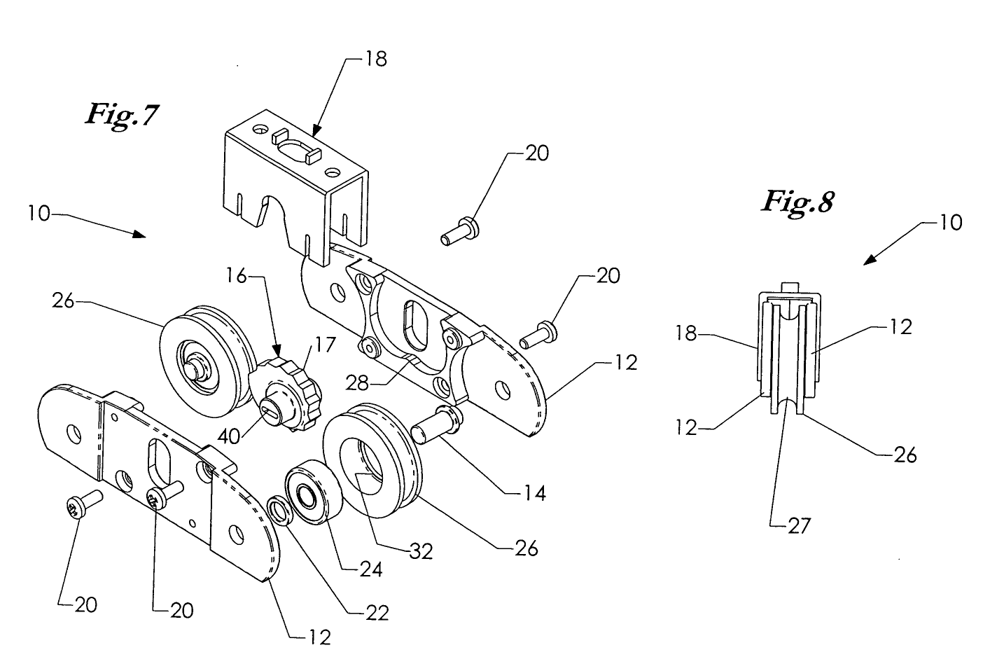

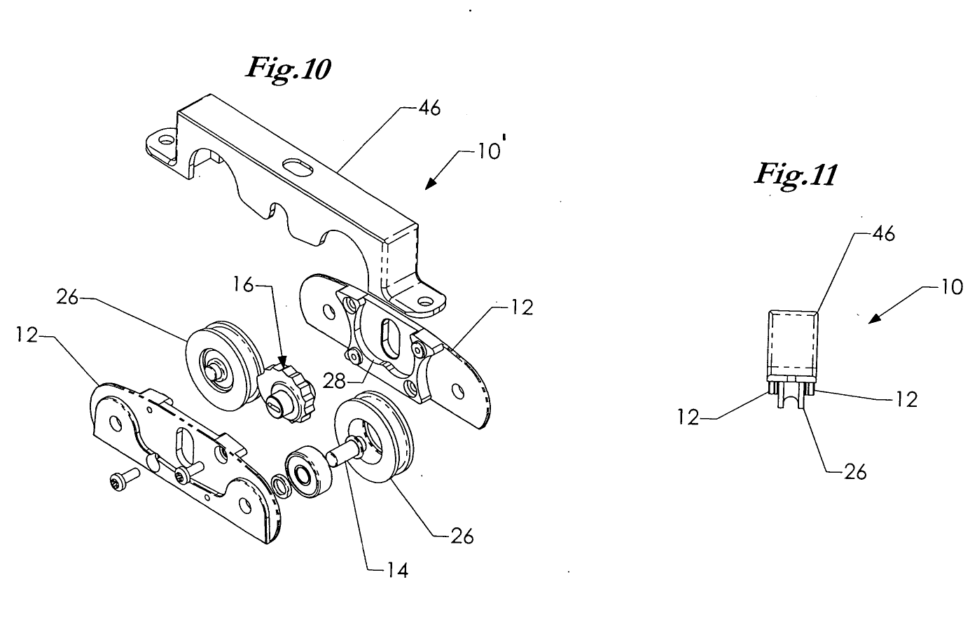

FIG. 5 illustrates a precision roller wheel assembly 10 having two wheels 26 retained in a housing 12 by axle 14. It is noted that housing 12 may extend beyond wheels 26 preventing damage to the wheels 26, as illustrated in FIGS. 10. The wheels 26 are sealed to bearings 24, shown in FIG. 7. An inner lip 32, shown in FIG. 7, of axle receiving wheel aperture 42 holds bearing 24 in place and provides a surface against which bearing 24 may be pressure fit by spring washer 22 or the like. Additionally, snap ring, adhesive or the like may be applied to the wheel inner aperture 42 to aid in retention of bearing 24. This sealing of the wheels 26 to the bearings 24 prevents foreign matter from getting into the wheel 26 and thereby causing deterioration of the wheel 26. Bracket mounting 18 is positioned atop housing 12. A pair of projections 50 are machined into bracket mounting 18, and may be used during installation. Because patio doors typically have a circular aperture formed in a bottom surface thereof, the projections 50 are used to fit into this circular aperture thereby assisting in the placement of the precision roller wheel assembly 10 in the appropriate position during installation, both in new manufacture and retro-fitting assembly into an existing patio door. Bracket mounting slots 21 enable the side panels of bracket mounting 18 to be bent outwardly which also aids in positioning precision roller wheel assembly 10 during installation. Once in position, precision roller wheel assembly 10 is fastened to the bottom surface of a patio door or the like. Screw holes 23 are provided, in bracket mounting 18 enabling installation by screw fasteners or the like to a bottom of a door.

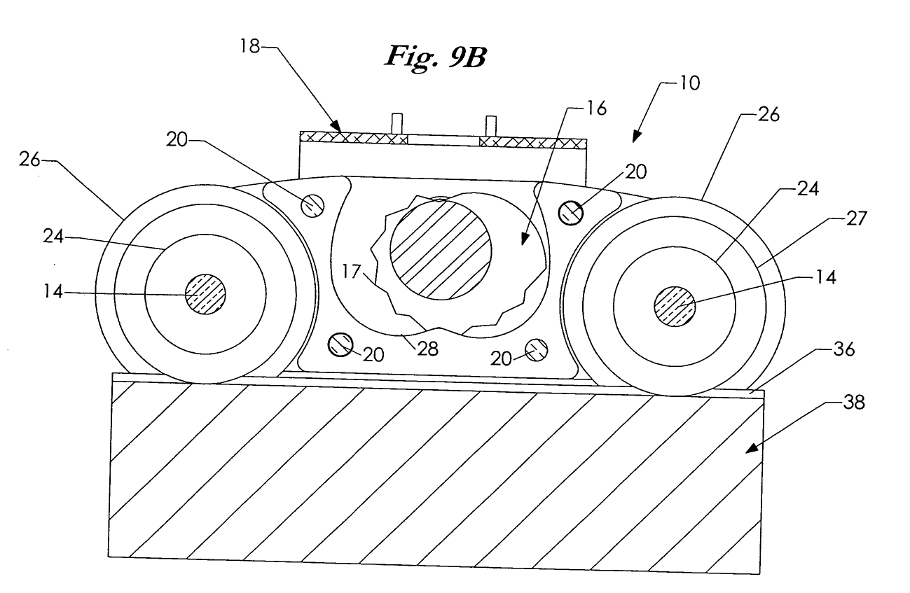

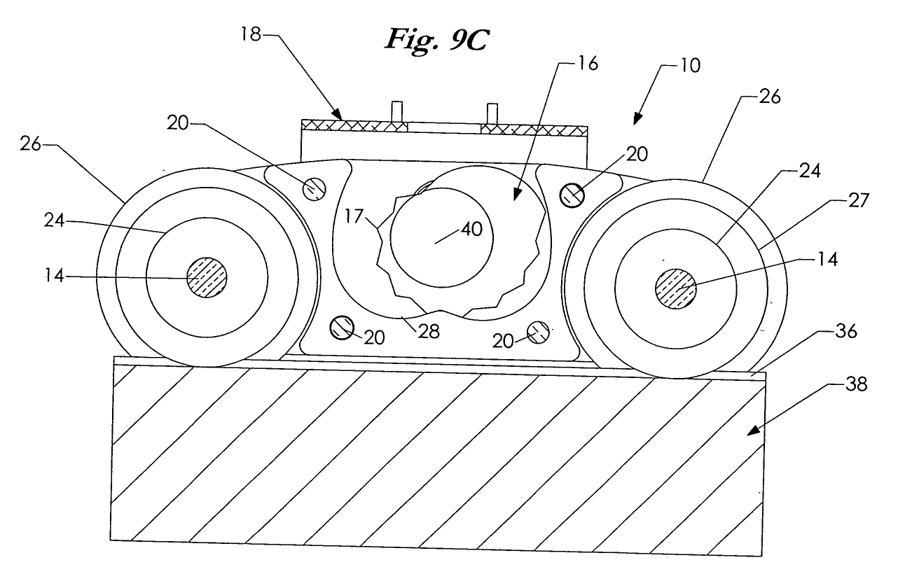

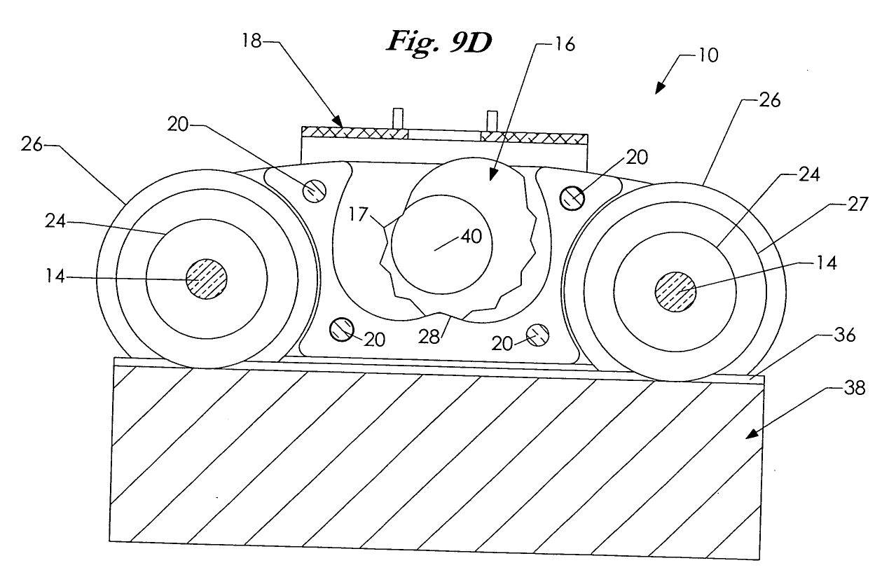

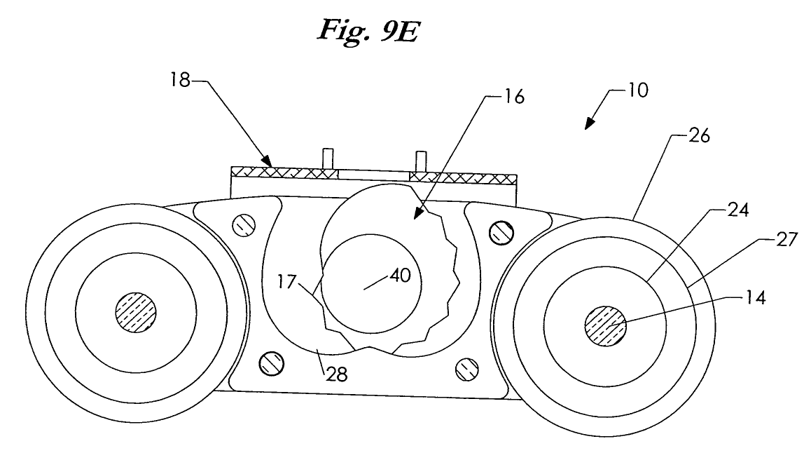

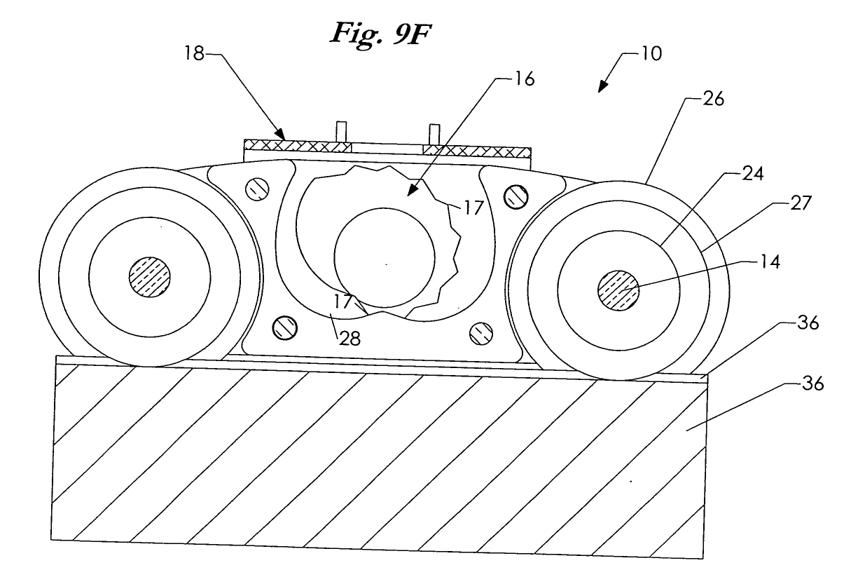

FIG. 6 illustrates that the housing 12 is a two-piece housing 12. Brass pins or screw fasteners 20 or the like hold the two-piece housing 12 together. A pair of wheels 26 are shown in place held within the housing 12. Bracket mounting 18 is shown positioned atop the two-piece housing 12. An opening 19, also shown at FIG. 7, is machined in bracket mounting 18 between projections 50 to allow cam gear 16 to be positioned such that it extends beyond the bracket mounting 18. Bracket mounting 18 together with cam gear 16 provide the vertical adjustment to precision roller wheel assembly 10. Adjustment arm 41 projects horizontally from cam gear 16 and contains adjustment slot 40. Bracket mounting 18 is raised or lowered by turning adjustment arm 41 which turns cam gear raising or lowering bracket mounting 18. Because of the unique irregular edge 56 shape of cam gear 16, shown in FIGS. 7, 9A-9E, cam gear 16 locks in place once in position. Cam gear 16 may be later adjusted by turning adjustment arm 41 by means of adjustment slot 40 if the weight of the door is removed from the precision roller wheel assembly 10, but vibration alone will not affect precision roller gear wheel assembly 10.

FIG. 7 is an exploded view of precision roller wheel assembly 10 to aid in understanding of the device of this invention. Housing 12 is a two-piece housing each piece being the mirror image of the other. A recess 13 is formed in the outside of each of two-piece housing 12 for receipt of bracket mounting 18. Bores 29 are formed in each of two-piece housing 12 for receipt of brass screws , pins or other fastening means 20. Bores 29 consist of a pair of male bores and a pair of female bores, on opposite corners of housing recess 13 such that they lock the two pieces of the two-piece housing together for fastening by screws or other fastening means 20. The side of the housing opposite the recess 13 has a cut-out portion forming the inner surface of housing 28 which provides a shelf-like surface for cam gear 16 to rest upon within two-piece housing 12. A point 31 on housing inner surface is received by various concavities 15 formed in cam gear 16. Cavity 11 formed in each of the two-piece housing 12 receives adjustment arm 41 in such a manner that adjustment arm 41 can be moved vertically within cavity 11. Axle 14 with assembled wheel 26, bearing 24 and spring lock washer 22 is snap fit into wheel aperture 42. Once cam gear 16 and wheel assemblies 26 are in position, the two-piece housing 12 is fastened together by fastening means described above. Groove 25, formed in bracket mounting 18, is shaped to receive adjustment arm 41 extending from cam gear 16 in a snap fit manner thus retaining bracket mounting 18 on assembled two-piece housing 12. Groove 25 is key-hole shaped with a flared bottom. The upper portion of groove 25 is shaped to receive the annular circumference of adjustment arm 41. Cam gear 16 is adjusted by means of turning adjustment arm 41 manually by means of a screw driver or the like received by slot 40. Turning adjustment arm 41 turns cam gear 16, a follower of adjustment arm 41, and re-positions the unique irregular-shaped cam gear 16 such that cam gear 16 and bracket mounting 18 moved in a vertical plane upwardly or downwardly thus moving the attached patio door upwardly or downwardly as needed.

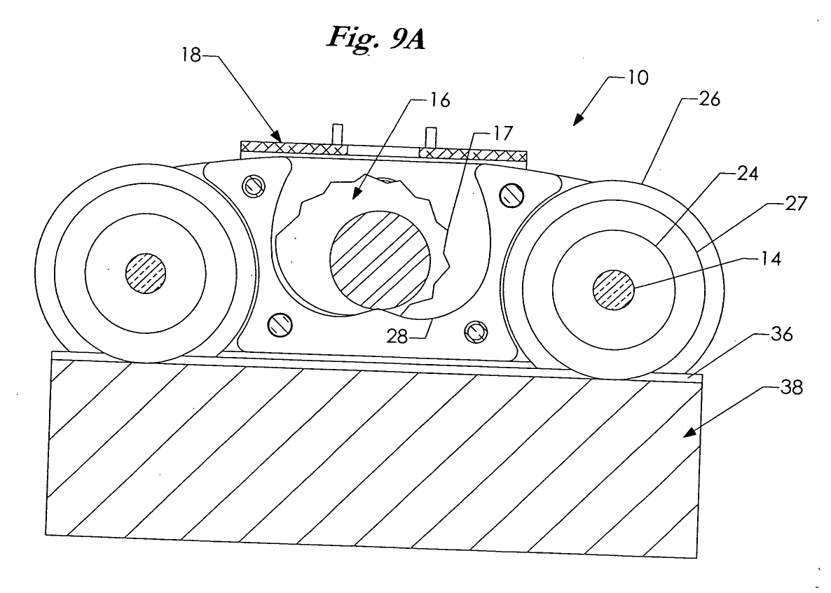

FIG. 8 illustrates the assembly 10 from an end view with the wheel 26 held in place within the two-piece housing 12 with mounting bracket 18 snapped onto adjustment arm 41 in place atop two-piece housing 12. Projection 50 is shown as it would appear for installation of assembly onto patio door or the like.

The two-piece housing 12, in actual use conditions, is of aluminum-bronze alloy and machined for a precise fit with the other components of this assembly 10. While this material is preferred because of its resistance to salt-water corrosion, other rust-resistant, resilient materials could be used. Each side of the housing is a mirror image of the other. The precision machining allows for a tight fit of the component parts, and further permits a tight fit of the patio door. While applicant believes the device of this invention would be able to withstand hurricane force winds, as per Florida statutes, the testing has not been done. The interior of the housing is shaped to allow cam gear 16 to rotate and move vertically for positioning. This re-positions cam gear 16 such that point 31 of inner surface 28 is received by a concavity 15 of cam gear 16 and cam gear 16 is locked into position. Wheels 26, shown in detail in FIG., in actual use conditions are of metal alloys such as aluminum bronze, or plastic acetyl composites such as Dupont Delrin®, nylon, neoprene, or combination material, although other materials such as special composites, could be used.

FIG. 9A-9F is a series of illustrations to teach the cam gear 16 adjustment system. The cam gear 16 adjustment system includes a cam gear 16 positioned between the pair of wheels 26. The cam gear 16 is able to be turned for positioning the roller assembly on a patio door such that a concavity 15 on an outer edge thereof 56 is locked into position when the concavity 15 comes into contact with a point 31 on an inner surface of housing 28. The irregular shaped cam gear 16 portion opposite the concavity 15 locked in position by the point 31 in turn lifts the bracket mounting 18 which in turn expands to fit into the space available of the structure attached thereto. FIG. 9A illustrates the cam gear 16 lifting system in the lowermost position, therefore, bracket mounting 18 because it rests on adjustment arm 41, is a slave to cam gear 16 also in its lowermost position. When precision roller wheel assembly 10 is in position along the bottom surface of a patio door, the cam gear 16 adjustment system adjusts the patio door, or the like, by raising or lowering any object of structure attached thereto such that it fits into the space available.

Two wheels 26 are retained in the housing 12 by a pair of axles 14 that permit the assembly 10 to move along a track. The bracket mounting 18, carried by the housing 12 is a slave to the movement of the adjustment arm 41. Slot 40, formed into cam gear 16, permits adjustment of cam gear 16 such that the bracket mounting 18 is either raised, FIG. 9E, or lowered, FIG. 9A depending on the adjustment of cam gear 16. FIGS. 9A-9F illustrate points in between the two extremes mentioned above. Once a patio door, not shown, is in the desired position, cam gear 16 is locked into place by the weight of the door on bracket mounting 18 holding concavity 15 of cam gear 16 in position atop point 31 of inner surface 28 of housing 12.

FIGS. 10 and 11 illustrate an alternate cam gear two-wheeled embodiment 10′ wherein the basic elements of the precision roller wheel assembly are the same as for the device of FIG. 5 -9F except the mounting bracket 46 is adapted for use with a wooden patio door, not shown. In this embodiment, mounting bracket 46 has a pair of flanges 52 each having an orifice 54 formed therein for receipt of screws or other fastening means. FIG. 10 is an exploded view and FIG. 11 is and end view.

Axle 14, of bronze or brass material, is used to retain the wheels 26 within the two-piece housing. Each wheel 26 is sealed to the axle 14 by means of a stainless steel bearing 24 and a brass Delrin® washer 22. The thickness of wheel 26 used varies depending on the need.

Cam gear 16, of aluminum or aluminum-bronze material, has projections 17 extending from all sides thereof. The cam gear 16 is held in place on the bottom of the two-piece housing 12 by a recess formed in both sides of the two-piece housing 12. Bracket mounting 18 restrains the cam gear 16 from coming out of the top side of the two-piece housing 12.

The bracket mounting 18, 46 is, in actual use conditions, also of aluminum but other rust-resistant resilient materials could be used such as aluminum-bronze. Bracket mounting 18 is retained in place on top of the two-piece housing 12 by the axle of the cam gear. Bracket mounting 18, because it is able to be adjusted by movement and locking of cam gear 16, in turn is able to adjust the patio door or other object mounted thereon, not shown. Projections 30 extend from an upper surface of bracket mounting 18 and are received by the patio door or other object to be moved by the disclosed assembly 10.

In use, either of the precision roller wheel assembly embodiments 10, 10′, bracket mounting 18 is raised or lowered by movement of the cam gear 16. Bracket mounting 18 tilts about the pivot of the cam gear 16. The close and precise machining of the parts and the materials used enable smooth and quiet movement of the assembly 10, and the patio door or other structure mounted thereon, along a track. The materials used resist deterioration by environmental elements, such as saltwater. Additionally, the close fit of the assembly 10 to the track and the patio door or other carried structure are able to withstand even hurricane-force winds during testing of the product.

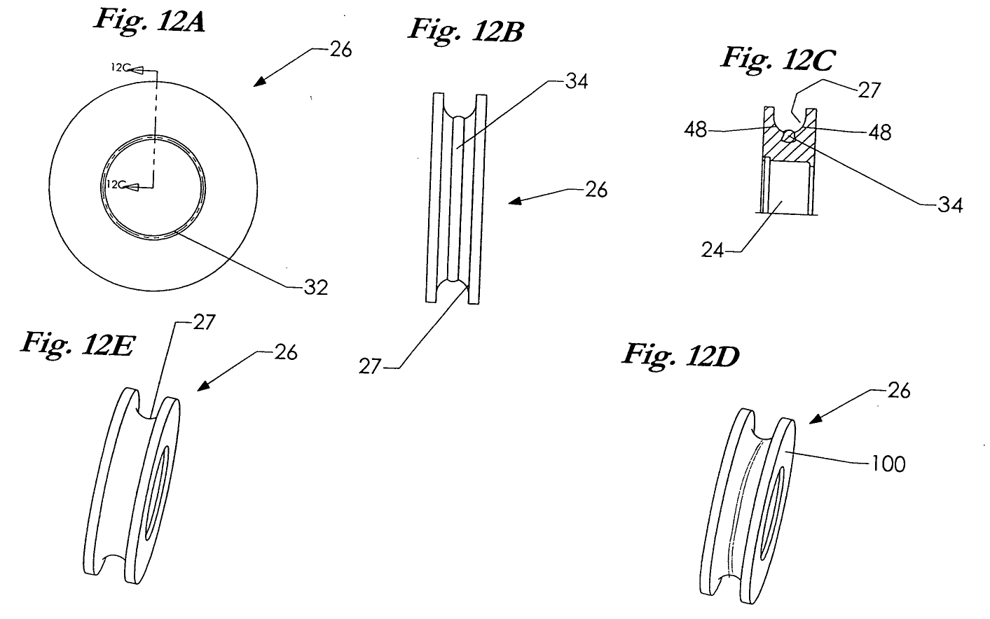

The assembly 10, 10′ are the resistance to both salt-water and rusting in general, and have the ability to withstand hurricane-force winds and yet provide the quiet operation of the assembly 10. The precision machined roller wheel assembly 10, 10′ adjusts the fitting of the assembly to the position of use and yet provides stability of the assembly because of cam gear 16. The unique shape of cam gear 16 permits a stable vertical adjustment of the mounting bracket 18 associated with a patio door or the like. Because the cam gear 16 is held in place by gravity once in position, the patio door mounted thereon is extremely stable. Also, the close fit permitted by the patio door to the track 38 on which it rides, enhances stability of the assembly-fit door, increases resistance to corrosion, and increases ease of use of the assembly mounted patio door. Wheel 26 is shown at FIG. 12A-12E, used in all embodiments, has a channel 27 machined therein to enable the wheel 26 to follow a track, such as one surrounding a patio door. It is understood that channel 27 of other sizes and shapes could be utilized. An optional wheel insert 34 can be manufactured into wheel 26 using plastics or urethane composites as the insert material, FIG. 12B and C. The wheel insert 34 acts as a shock absorber and provides additional smoothness and ease of operation of the precision roller wheel assembly equipped patio door because as it slightly deforms or changes the shape of the curve of channel 27, it creates two surfaces that roll on the track which transfers pressure from the center of the track to the side pressure points 48 of the wheel 26. FIG. 12D a perspective view of two-piece wheel 26′ held together by a pair of screws or other fastening means, the two mirror image pieces held together by fastening means through aperture 100, that uses a wheel 26′ of natural or man-made rubber such as Neoprene® or other equal displacing material and as such acts as a shock-absorber that extends the life of wheel and track and additionally reduces the noise associated with use of the patio door, or the like. Additionally, the shock-absorbing qualities of a rubber wheel also contributes to smooth operation of the patio door, or the like, by providing a reduced-friction operation thereof. FIG. 12E is a machined one piece wheel 26 having a channel 27 machined therein with a relatively deeper groove and wider sidewalls yet still having an outside dimension the same as the industry standard.

Although the present invention has been described in considerable detail with reference to certain preferred versions thereof, other versions are possible. Any retracting door, such as a pocket door or other load bearing moving object could utilize these wheel assemblies. Therefore, the spirit and scope of the appended claims should not be limited to the description of the preferred versions contained herein.

I claim:

1. (canceled)

2. (canceled)

3. (canceled)

4. (canceled)

5. (canceled)

6. The assembly of claim 4, wherein said housing further comprises:
a two-piece precision machined outer housing, which when combined forms a generally U-shape outer housing;
a one-piece precision machined inner housing having a hollowed-out central cavity, such that the inner housing is an elongated O shape, said inner housing having a pair of diagonal notches formed in opposite long sides thereof;
said at least one wheel or roller having a axle extending from both sides thereof, the axle received by the diagonal notches of said inner housing; and
means for retaining said at least one wheel or roller within said assembly.

7. The assembly of claim 6, wherein said two-piece precision machined outer housing further comprises a pair of apertures formed in the two-piece outer housing, the apertures for receiving attachment means, the apertures further comprising a boss precision machined into one of the said two-piece outer housing and a boss-receiving counter bore precision machined into the other of said two-piece outer housing.

8. The assembly of claim 6, wherein said means for retaining said at least one wheel or roller within said assembly further comprises a generally vertical counter-machined groove on opposite inner sides of each of said two-piece outer housing, said groove for receiving and capturing said axles of said wheel or roller.

9. The assembly of claim 8, wherein said means for retaining said at least one wheel or roller within said assembly further comprises a counter-machined slot found on opposite inner sides of each of said two-piece outer housing.

10. The assembly of claim 9, wherein said means for retaining said at least one wheel or roller within said assembly further comprises a pair of boss pins, one on each outer side of said inner housing long sides, said boss pins received by said counter-machined slots of said two-piece outer housing.

11. The assembly of claim 6, further comprising adjustment means for adjusting said assembly in its position of use.

12. The assembly of claim 11, further comprising a central recess, one half formed on each of said two-piece outer housing, said central recess for receiving an adjustment screw.

13. The assembly of claim 12, further comprising an aperture formed in one end of said inner housing, said aperture for receiving said adjustment screw.

14. The assembly of claim 13, wherein said adjustment means further comprises movement of said wheel along said diagonal notch by said two-piece outer housing capturing said axle within said counter-machined groove such that the axle moves diagonally upwardly or downwardly within said diagonal notch in response to movement of said two-piece outer housing in relation to said inner housing, once in position the vertical adjustment screw being tightened to secure said assembly in the desired position.

15. The assembly of claim 6, further comprising a weather-sealed wheel.

16. The assembly of claim 15, wherein said weather-sealed wheel further comprises a washer held in position by a bearing in turn held in position by a retaining ring such that water and salt water are sealed out from the wheel or roller axle.

17. An improved machined wheel or roller assembly that provides a rust-resistant, salt resistant wheel or roller assembly for providing a smooth gliding, quiet operating, easy to adjust patio door wheel system, comprising:
a two-piece precision machined outer housing, which, when combined, forms a generally U-shaped outer housing;
a one-piece precision machined inner housing having a hollowed-out central cavity, such that the inner housing is an elongated O-shape, said inner housing having a pair of diagonal notches formed in opposite long sides thereof;
at least one wheel or roller having an axle extending from both sides thereof, the axle received by the diagonal notches of said inner housing; and
means for retaining said at least one wheel or roller within said assembly.

18. The assembly of claim 4, wherein said housing further comprises:
a two-piece precision machined outer housing, having on an inside edge thereof, a generally horizontally placed counter-machined slot on each of the two-pieces and;
a one-piece precision machined inner housing having a hollowed-out central cavity, such that the inner housing is an elongated O shape, said inner housing having a pair of diagonal notches formed in opposite long sides thereof;
said wheel or roller having a axle extending from both sides thereof, the axle received by the diagonal notches of said inner housing.

19. The assembly of claim 4, wherein said housing further comprises:
a two-piece precision machined outer housing, which when combined, forms a generally elongated O-shaped outer housing;
a one-piece precision machined inner housing having a hollowed-out central cavity, such that the inner housing is an elongated O shape, said inner housing having at least a pair of diagonal notches, with an open lower end, formed in opposite long sides thereof; and
said at least one wheel or roller having a axle extending from both sides thereof, the axle received by the paired diagonal notches of said inner housing.

20. The assembly of claim 19, wherein said two-piece precision machined outer housing further comprises a pair of shoulders for joining the ends of the two-piece outer housing with apertures formed therein, the apertures for receiving fastening means, the apertures further comprising a boss precision machined into one of the said two-piece outer housing and a boss-receiving counter bore precision machined into the other of said two-piece outer housing such that the fitting together of the boss and counter bore assist in keeping the two-piece outer housing assembled.

21. The assembly of claim 19, wherein said means for retaining said at least one wheel or roller within said assembly further comprises a pair of generally vertical counter-machined grooves on opposite inner sides of each of said two-piece outer housing, said grooves for receiving and capturing said axles of said wheel or roller.

22. The assembly of claim 19, wherein said two-piece outer housing further comprises a pair of tube-like members formed centrally along the long sides as part of each of the two-piece housing, said pair of tube-like members for receiving a spacer for stabilizing the two-piece outer housing and preventing deforming of said housing, said spacer fastened by fastening means received centrally by the joined pair of tube-like members.

23. The assembly of claim 19, wherein said a one-piece precision machined inner housing further comprises a pair of horizontal notches formed in opposite long sides thereof for receiving and allowing for adjustment thereof of said spacer.

24. The assembly of claim 19, wherein said one-piece precision machined inner housing further comprises two pairs of diagonal notches, formed on opposite long sides thereof with an open lower end, for receiving a pair of wheels or rollers.

25. The assembly of claim 4, further comprising adjustment means for adjusting said assembly in its position of use.

26. The assembly of claim 25, wherein said adjustment means further comprise an adjustment screw received by a central recess formed in both of the assembled two-piece outer housing and a corresponding aperture formed in said inner housing.

27. The assembly of claim 26, wherein said adjustment means further comprises movement of said wheel along said diagonal notch by said two-piece outer housing capturing said axle within said counter-machined groove such that the axle moves diagonally upwardly or downwardly within said diagonal notch in response to movement of said two-piece outer housing in relation to said inner housing, once in position the vertical adjustment screw being tightened to secure said assembly in the desired position.

28. The assembly of claim 19, further comprising a weather-sealed axle.

29. The assembly of claim 28, wherein said weather-sealed axle further comprises a washer held in position by a bearing in turn held in position by a retaining ring such that water and salt water are sealed out from the wheel or roller axle.

30. An improved precision machined wheel or roller assembly that provides a rust-resistant, salt resistant wheel or roller assembly for providing a smooth gliding, quiet operating, easy to adjust patio door wheel system, comprising:
a two-piece precision machined outer housing, which, when combined, forms a generally elongated O-shaped outer housing;
a one piece precision machined inner housing having a hollowed-out central cavity, such that the inner housing is an elongated O-shape, said inner housing having at least a pair of diagonal notches, with an open lower end, formed in opposite long sides thereof;
at least one wheel or roller having an axle extending from both sides thereof, the axle received by the pair of diagonal notches of said inner housing; and
means for retaining said at least one wheel or roller within said assembly.

31. The assembly of claim 30, wherein said inner housing further comprises:
two pairs of diagonal notches, with an open lower end, formed in opposite long sides thereof; and
a pair wheels each having an axle extending from both sides thereof, the axle received by the diagonal notches of said inner housing.

32. (canceled)

33. (canceled)

34. (canceled)

35. (canceled)

36. (canceled)

37. A method of manufacturing a roller wheel assembly that provides a rust-resistant, salt resistant wheel or roller assembly for providing a smooth gliding, quiet operating, easy to adjust patio door wheel system, comprising the steps of:
a) precision machining wheel proportions into metal materials selected from a group including stainless steel, aluminum, copper metal alloys, and plastic acetyl, the wheel having a relatively deep inner groove and relatively thicker sidewalls such that the outer dimensions remains the industry standard size;
b) processing the wheel by de-burring and coating the wheel by one of a group including anodizing and metal plating;
c) machining a two-piece outer housing of required dimensions of materials selected from a group including stainless steel, aluminum, copper metal alloys, and plastic acetyls;
I) forming a horizontal machined slot, a vertical groove and a recess formed in the first end of the outer housing joining ends of the outer housing, such that a boss is formed in one piece of the two-piece housing and a matching counter-bore formed in the second piece of the two-piece outer housing;
d) processing the outer housing by de-burring and coating the metal materials;
e) machining a one piece inner housing of required dimensions of materials selected from a group including stainless steel, aluminum, copper, metal alloys, and acetyl composites, the inner housing formed with closed ends;
f) processing the inner housing by de-burring and coating the metal materials;
g) machining a pair of wheel mounting notches formed diagonally in side walls of the inner housing and forming a boss pin and a recess;
h) assembling the wheel by positioning axle into a bearing, press fitting the bearing into the wheel, locking the bearing into place with a snap ring and washer;
I) positioning the two-piece outer housing about the wheel mounted inner housing and fastening with fastening means; and
j) providing an adjustment screw positioned at an end for vertically adjusting the in position roller wheel assembly.

38. The method of claim 37, further comprising the further step of inserting a rubber insert into a groove machined into the wheel as a shock absorber.

39. A method of manufacturing a roller wheel assembly comprising the steps of:
a) precision machining wheel proportions into metal materials selected from a group including stainless steel, aluminum, copper metal alloys, and plastic acetyls, the wheel having a relatively deep inner groove and relatively thicker sidewalls such that the outer dimensions remains the industry standard size;
b) processing the wheel by de-burring and coating by one of a group including anodizing and metal plating;
c) machining a two-piece outer housing of metal materials selected from a group including stainless steel, aluminum, copper metal alloys, and plastic acetyls, into desired dimensions;
I) further machining a pair of vertical grooves in each of the two piece outer housing;
ii) machining a pair of shoulders one on the inside sidewall of each of the two-piece outer housing; providing on each a boss and a counter bore for tightly fitting the two-piece outer housings together;
d) machining a one-piece inner housing into desired proportions from metal materials selected from a group including stainless steel, aluminum, copper metal alloys, and plastic acetyls;
e) machining a pair of wheel mounting diagonal notches in each sidewall of the inner housing;
f) providing a pair of wheel assemblies, assembling the wheel by positioning an axle into a bearing, press fitting the bearing into the wheel, locking the bearing into place with a snap ring and washer;
g) providing a spacer received by the members of the inner housing and received by a movement slot machined into each sidewall of the inner housing;
h) positioning the two-piece outer housing about the wheel mounted inner housing and fastening with fastening means; and
I) providing an adjustment screw positioned at an end for vertically adjusting the in position roller wheel assembly.

40. The method of claim 39, further including the step of inserting a rubber insert into a groove machined into the wheel as a shock absorber.

41. A method of manufacturing a roller wheel assembly having the steps of:
a) precision machining wheel proportions into metal materials selected from a group including stainless steel, aluminum, copper metal alloys, and plastic acetyls, the wheel having a relatively deep inner groove and relatively thicker sidewalls such that the outer dimensions remains the industry standard size;
b) processing the wheel by de-burring and coating by one of a group including anodizing and metal plating;
c) machining a two-piece housing of materials selected from a group including stainless steel, aluminum, copper metal alloys, and plastic acetyls, into desired dimensions;
I) further machining an inner surface on the inside side walls of the two-piece housing;
ii) further machining a bracket mounting machined from materials selected from a group including stainless steel, aluminum, copper metal alloys, and plastic acetyls;
d) providing a cam gear received by the inner surface of the two-piece housing, the cam gear positioned to raise or lower the bracket mounting;
e) providing at least one wheel, assembling the wheel by positioning an axle into a bearing, press fitting the bearing into the wheel, locking the bearing into place with a snap ring and washer;
f) assembling the two-piece housing about the positioned at least one wheel and cam gear;
g) mounting the bracket mounting by snap fit onto the wheel mounted assembled two-piece housing; and
f) mounting the assembled roller wheel assembly onto the bottom edge of a patio door for receipt of the roller wheel assembly by a track associated therewith.

42. (canceled)

43. (canceled)

44. (canceled)

45. (canceled)

46. (canceled)

47. (canceled)

48. (canceled)

49. (canceled)

50. (canceled)
